(19) United States
(12) Patent Application Publication
(10) Pub. No.: US 2026/0320870 A1
(43) Pub. Date: Oct. 15, 2026

(54) MULTIMEDIA PROCESSING METHOD, SYSTEM, AND VEHICLE

(71) Applicant: HONDA MOTOR CO., LTD., Tokyo (JP)

(72) Inventors: Ziying Chen, Guangdong (CN); Yu Komuro, Guangdong (CN); Yijie Guo, Guangdong (CN); Zhong Liu, Guangdong (CN); Ye Yao, Guangdong (CN)

(21) Appl. No.: 19/634,599

(22) Filed: Mar. 31, 2026

(30) Foreign Application Priority Data
Apr. 9, 2025 (CN) 202510443209.3

(51) Int. Cl. G06T 11/60; G06F 3/16; G10H 1/00

(52) U.S. Cl. CPC G06T 11/60; G06F 3/165; G10H 1/0008; G10H 1/0041; G06F 3/167; G10H 2210/031; G10H 2240/016

(57) ABSTRACT

A multimedia processing method includes a step of acquiring a music file, a step of generating a music feature of the music file based on the music file, a step of determining an image theme and a visual template that match the music feature, a step of determining an image feature related to the music feature, and a step of generating an image that matches the music file based on the image theme, the visual template, and the image feature.

### INCORPORATION BY REFERENCE

The present application claims priority under 35 U.S.C. § 119 to Chinese Patent Application No. 202510443209.3 filed on Apr. 9, 2025. The content of the application is incorporated herein by reference in its entirety.

### BACKGROUND OF THE INVENTION

### Field of the Invention

The present invention relates to a multimedia field, and more particularly to a multimedia processing method, a system and a vehicle.

### Description of the Related Art

With the improvement in living standards of people and increasing demand for entertainment, technologies such as multimedia processing and multimedia playback have been rapidly developed, and demand for various functions of a multimedia device is also growing day by day.

Music is one of important forms of multimedia and occupies an important position in daily lives of people and culture exchange. Currently, in addition to basic functions of playing back music and adjusting a volume, mainstream music playback software can support synchronized display of lyrics, a singer, images of an album, and the like, and can support selection of sound effect modes for pops, rock, classic, jazz, base boost, and the like. Some kinds of software also allow a user to customize acoustic effect parameters, and, for example, allows the user to adjust gains of different frequencies through a tool such as an equalizer (EQ) to achieve personalized sound quality.

Note that the introduction of the technical background described above is described only for the purpose of convenience to clearly and completely explain technical solutions of the present invention to allow a person skilled in the art to easily understand the technical solutions of the present invention. The above-described technical solutions should not be recognized as being well-known by a person skilled in the art only because these solutions are described in the technical background of the present invention.

The inventors have noticed that with the above-described related art, content that is displayed in synchronization with music during playback of the music is normally lyrics, a singer, or images of an album, and display content and a display method are relatively simple, and thus, characteristics and sense of music that is being currently played back cannot be sufficiently expressed. Further, the inventors have noticed that these simple display content and monotonous display method easily bore a user and are inferior in usage experience.

Further, a certain level of expertise is required for a user to adjust various kinds of acoustic effect parameters through a tool such as an equalizer, which limits a user base. Still further, an adjustment interface of the acoustic effect parameters of the tool such as an equalizer is relatively monotonous and does not provide an intuitive feedback of the adjustment, and thus is inferior in user experience.

### SUMMARY OF THE INVENTION

In order to solve one or a plurality of problems in the related art described above, or similar problems, an example of the present invention provides a multimedia processing method capable of generating a vivid and unique image having a high matching degree with a music file, and improving user experience through auditory and visual bidirectional enhancement, a system and a vehicle.

According to a first aspect of the example of the present invention, a multimedia processing method is provided, the method including a step of acquiring a music file, a step of generating a music feature of the music file based on the music file, a step of determining an image theme and a visual template that match the music feature, a step of determining an image feature related to the music feature, and a step of generating an image that matches the music file based on the image theme, the visual template, and the image feature. This allows a user to view an image with a high matching degree with music while enjoying the music and improves user feeling of experience by bringing how the user feels abstract music closer to what the user can see and what the user can feel by auditory and visual bidirectional enhancement.

The step of acquiring the music file may include a step of acquiring a music file from a local device or a step of acquiring a music file from a server on a cloud, or a step of acquiring a music file created by a user. By this means, the music file can be acquired through various routes, which improves flexibility of acquisition of the music file and abundance of music resources and, further, makes it possible to more easily satisfy the needs of the user from various routes.

The step of generating the music feature of the music file based on the music file may include a step of determining at least one main musical element belonging to the music file based on the music file, and a step of generating a music feature of the music file based on the music file and the main musical element. As a result of the music feature being generated by determining the main musical element of the music file in this manner, the music feature can be comprehensively and accurately determined from various perspectives, which improves a matching degree between the image to be generated and the music file and further improves the user experience.

The step of determining at least one main musical element belonging to the music file may include a step of analyzing the music file, acquiring a plurality of musical elements, and determining correlation between the music file and the plurality of musical elements, and a step of selecting from the plurality of musical elements, at least one musical element for which the correlation satisfies a preset condition and setting the at least one musical element as a main musical element belonging to the music file. By finding a musical element having strong correlation with the music file through analysis of the music file and using the musical element as the main musical element of the music file to generate an image in this manner, it is possible to further increase the matching degree between the image to be generated and the music file and further improve user experience.

The music feature may include at least one of a musical style, content of lyrics, a feeling and a thought expressed by music, or music rhythm. By generating the music feature containing multidimensional information in this manner, it is possible to further increase the matching degree between the image to be generated and the music file and express characteristics of the music from different aspects through the image, which further improves the user experience.

The step of determining the image theme and the visual template that match the music feature may include a step of determining an image theme that matches the musical style and/or the content of the lyrics, and a step of determining a visual template that matches at least one of the feeling and the thought expressed by the music or the music rhythm. By this means, appropriate image theme and visual template can be determined from a plurality of dimensions of the music, so that the matching degree between the image to be generated and the music is further increased.

The step of determining the image feature related to the music feature may include a step of extracting an image feature for which correlation with the music feature satisfies the preset condition from an image database. By extracting the image feature for which the correlation satisfies the preset condition from the image database containing a large amount of image features to generate an image, it is possible to improve abundance of the image to be generated and increase a matching degree with the music.

Types of the music feature and/or the musical element may be determined in advance. For example, the musical element and the music feature can be set in advance using publicly available data sets, and the musical element and the music feature can be thereby comprehensively extracted.

The types of the music feature and/or the musical element may be determined based on selection or adjustment by the user. For example, the user can select or adjust the musical element and the music feature during use, which makes it possible to make the image further match user's preference and needs and eventually generate an image that is better fit for the user's preference, so that the user experience is further improved.

The step of determining the image feature related to the music feature may include a step of generating a character feature corresponding to the music feature, and a step of inputting the character feature to an artificial intelligence model and acquiring an image feature related to the music feature. In this manner it is possible to efficiently acquire the image feature related to the music feature through a model for acquiring an image feature based on the character feature, so that efficiency of image generation is further improved.

The step of generating the image that matches the music file may include a step of generating the image that matches the music file based on a generative artificial intelligence model. This enables efficient generation of an image with a high matching degree.

The method may further include the following steps of: a step of, in a case where the generated music file includes a plurality of music features, determining priority of the plurality of music features; and a step of determining an image theme and a visual template that match the music features. The step of determining the image theme and the visual template that match the music feature includes a step of determining an image theme and a visual template that match a music feature with the highest priority among the plurality of music features, and/or a step of determining an image feature related to the music feature. The step of determining the image feature related to the music feature includes a step of determining an image feature related to the music feature with the highest priority among the plurality of music features. In this manner, in a case where the music file to be generated includes a plurality of music features, an image theme and a visual template that match the music feature with the highest priority are determined, and an image feature is determined in accordance with priority, so that the image to be generated can be made to match the music feature with the highest priority.

The method may further include a step of playing back music corresponding to the music file and displaying the generated image in synchronization with the music. This allows the user to synchronously feel the music auditorily and visually, so that the user experience is improved.

The method may further include a step of dynamically updating the music feature in real time during a playback process of music corresponding to the music file and dynamically updating the image based on the dynamically updated music feature. By the image being dynamically updated during the playback process of the music in this manner, it is possible to present an image dynamically related to progression and climax of a song, a feeling to be expressed, and the like, so that the user can feel change in the song and the image in synchronization, which further improves the user experience.

The step of dynamically updating the music feature in real time during the playback process of the music corresponding to the music file and dynamically updating the image based on the dynamically updated music feature may include a step of dynamically updating the music feature based on at least one of a playback time, a structure, rhythm, a volume, or change of a feeling of the music, and dynamically updating at least one of a display parameter, display content or a display format of the image based on the dynamically updated music feature. By the display parameter such as luminance and chroma of the image or content to be displayed or a display format (for example, a dynamic effect) being dynamically updated based on the progression and a climax portion of the music, change of the feeling, and the like, a display effect that the image and the music change in synchronization with each other is further improved.

The method may further include a step of adjusting at least one image parameter of the image in response to an adjustment command for the image, a step of adjusting a music parameter corresponding to the image parameter based on the adjusted image parameter, and a step of updating the music file based on the adjusted music parameter. By adjusting the image parameter of the image that matches the music by utilizing relevance between the image parameter and the music parameter, the user can adjust the related music parameter correspondingly. It is thereby possible to make a correction on the music, that is, a tuning function based on image adjustment, so that the user can put a tuning function into use in an intuitive, simple, and innovative way, which improves fun of use and usability and improves the user experience.

A correspondence relationship between the image parameter and the music parameter may be determined in advance, which enables music adjustment based on image adjustment in a simple way.

A correspondence relationship between the image parameter and the music parameter may be determined based on relevance between the image parameter and the image feature, relevance between the image feature and the music feature, and relevance between the music feature and the music parameter. By providing the correspondence relationship between the adjusted image parameter and the adjusted music parameter based on the relevance among the image parameter, the image feature, the music feature, and the music parameter, it is possible to establish a correspondence relationship between the image parameter and the music parameter in a deeper level and from more dimensions, which is advantageous in achieving complicated and advanced adjustment for the image and the music.

The method may further include a step of displaying a music tag corresponding to the music feature, a step of dynamically updating the music feature in real time during a playback process of the music corresponding to the music file and dynamically updating the music tag based on the dynamically updated music feature. By the music tag being dynamically updated based on playback of the music in this manner, the user can intuitively feel change of the characteristics of the music, which further improves the user experience.

The method may further include a step of adjusting the music tag in response to an adjustment command for the music tag, a step of adjusting a music parameter corresponding to the music tag based on the adjusted music tag, and a step of updating the music file based on the adjusted music parameter. In this way, a tuning function of adjustment can be put into use based on the music tag, which improves the user experience.

The adjustment command may be generated based on a voice command and/or operation on a displayed widget. By this means, the image and/or the music can be adjusted in various ways, which improves usability by the user.

The method may further include a step of updating the image that matches the music file based on the updated music file, and a step of playing back music corresponding to the updated music file and displaying the updated image in synchronization with the music. This allows the user to intuitively feel feedback of an adjustment effect from both auditory and visual perspectives.

The method may further include a step of generating and displaying a recommended adjustment plan correlated with an image and/or a music file based on an analysis result of collected user data. This makes it possible to provide a recommended adjustment plan based on popularity and trend based on analysis of big data, so that it is possible to assist the user to quickly find an adjustment plan that matches the user's preference, which further improves the user experience.

The method may further include a step of receiving a voice command for adjusting the music file and/or the image, generating a recommended adjustment plan for the music file and/or the image, and updating the music file and/or the image after obtaining confirmation or correction by the user. In this manner, even if the user does not make specific adjustment setting, it is possible to present the recommended adjustment plan based on the voice command of the user and allow the user to make confirmation or correction, so that it is possible to bring the plan after being confirmed by the user closer to the user needs, which further improves the user feeling of experience.

According to a second embodiment of the example of the present invention, a multimedia system including a multimedia processing apparatus that implements the multimedia processing method according to the first embodiment of the example of the present invention is provided, the system further including a sound output device that outputs music corresponding to a music file, and a display device that, if the music corresponding to the music file is output, displays the image that matches the music file in synchronization with the music.

According to a third embodiment of the example of the present invention, a vehicle including the multimedia system according to the second embodiment of the example of the present invention is provided.

One of beneficial effects of the example of the present invention is as follows:

A vivid and unique image with a high matching degree with a music file is generated based on an image theme and a visual template that match a music feature of the music file, and an image feature related to the music feature, thereby at the time of playback of music, the image that matches the music can be displayed in synchronization with the music, which allows the user to view the image with a high matching degree with the music while enjoying the music and improves the user feeling of experience by bringing how the user feels abstract music closer to what the user can see and what the user can feel by auditory and visual bidirectional enhancement.

Further, the image is generated using the image theme and the visual template that match the music feature in combination with the image feature related to the music feature, so that the generated image embodies the music features from a plurality of dimensions, which enriches all of a display format, content and details of the image. Thus, if the generated image is displayed at the same time as the music being played back, the user can intuitively feel characteristics and sense of the music from both visual and auditory perspectives, which easily attracts sympathy and effectively improves the user experience.

The embodiments of the present invention will be disclosed in detail with reference to description which will be described later and the drawings. It should be understood that a scope of the embodiments of the present invention is not limited by this disclosure. The embodiments of the present invention include many changes, corrections, and equivalents within a scope of the gist and provisions of the attached claims.

Features described and/or indicated in a certain embodiment can be used in a similar manner in one or more other embodiments, and can be combined with features of other embodiments or replaced with the features of the other embodiments.

It should be emphasized that in a case where the term “include/contain/comprise” is used in the present specification, this means existence of a feature, a member, or an assembly, but does not exclude existence or addition of one or more other features, members, or assemblies.

The above and other objects, features, and advantages of the examples of the present invention will become more clear from the following detailed description provided along with the drawings.

### BRIEF DESCRIPTION OF THE DRAWINGS

FIG. 1 is a block diagram of a multimedia processing method according to an example of the present invention;

FIG. 2 is a block diagram for implementing a method in step 102 according to the example of the present invention;

FIG. 3 is a block diagram for implementing a method in step 104 according to the example of the present invention;

FIG. 4 is a block diagram of a music playback interface according to the example of the present invention;

FIG. 5 is another block diagram of the multimedia processing method according to the example of the present invention;

FIG. 6 is another block diagram of the multimedia processing method according to the example of the present invention;

FIG. 7 is another block diagram of the multimedia processing method according to the example of the present invention;

FIG. 8 is another block diagram of the multimedia processing method according to the example of the present invention;

FIG. 9 is a block diagram of a multimedia processing apparatus according to the example of the present invention; and

FIG. 10 is a block diagram of a multimedia system according to the example of the present invention.

### DETAILED DESCRIPTION OF THE PREFERRED EMBODIMENTS

The above and other features of the present invention will be made clear by the following description with reference to the drawings. While specific embodiments of the present invention are specifically disclosed in the description and the drawings, these indicate some of the embodiments that can employ the principle of the present invention, and it should be understood that the present invention is not limited to the described embodiments and includes all corrections, modifications, and equivalents included in the accompanying claims.

A multimedia processing method, an apparatus, a system, and a vehicle according to an example of the present invention will be specifically described below along with the drawings.

### Example of First Embodiment

An example of the present invention provides a multimedia processing method.

The multimedia processing method according to the example of the present invention can be executed by one or a plurality of apparatuses or devices having a multimedia processing function, and, for example, all steps of the present method can be executed by the same apparatus or device, or respective steps of the method can be executed by different apparatuses or devices. The example of the present invention does not limit types and the number of subjects that execute the method.

Further, the apparatus or the device that executes the multimedia processing method according to the example of the present invention may be either a local device or a device on a cloud. For example, the local device includes, but not limited to, a multimedia playback device, a mobile terminal, an in-vehicle terminal, and the like, and the device on the cloud includes, but not limited to, a server on the cloud, and the like. Alternatively, the apparatus or the device that executes the multimedia processing method may be an aggregate of the above-described different devices, that is, different devices may execute respective partial steps.

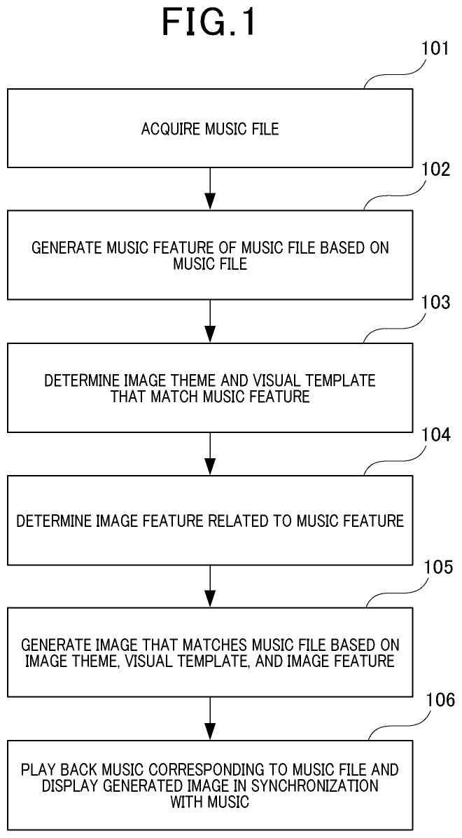

FIG. 1 is a block diagram of the multimedia processing method according to the example of the present invention. As indicated in FIG. 1, the method includes the following steps:
step 101: acquire a music file;
step 102: generate a music feature of the music file based on the music file;
step 103: determine an image theme and a visual template that match the music feature;
step 104: determine an image feature related to the music feature; and
step 105: generate an image that matches the music file based on the image theme, the visual template, and the image feature.

A vivid and unique image with a high matching degree with the music file is generated base on the image theme and the visual template that match the music feature of the music file, thereby, at the time of playback of music, an image that matches the music can be displayed in synchronization with the music, which allows the user to view an image with a high matching degree with the music while enjoying the music and improves user feeling of experience by bringing how the user feels abstract music closer to what the user can see and what the user can feel by auditory and visual bidirectional enhancement.

Further, the image is generated using the image theme and the visual template that match the music feature in combination with the image feature related to the music feature, so that the generated image embodies the music features from a plurality of dimensions, which enriches a display format, content, and details of the image. Thus, if the generated image is displayed at the same time as the music being played back, the user can intuitively feel characteristics and sense of the music from both visual and auditory perspectives, which easily attracts sympathy and effectively improves the user experience.

The respective steps of the method will be specifically described below. The following description is provided for the purpose of providing a better understanding of the present invention and does not limit the present invention.

In step 101, a music file can be acquired from a local device, a music file can be acquired from a server on a cloud, or a music file created by the user can be acquired. By this means, the music file can be acquired through various routes, which improves flexibility of acquisition of the music file and abundance of music resources, and further, makes it possible to more easily satisfy the needs of the user from various routes. The music file described here may be an audio signal stream corresponding to music.

In some examples, acquisition of the music file can be triggered by various methods, and, for example, the corresponding music file can be acquired based on selection by the user or the corresponding music file can be acquired based on a push notification to the user.

In some examples, the music file may be a music file that is locally stored, a music file from a network, for example, a music file on a cloud server, or a music file created by the user himself/herself.

In some examples, the music file corresponds to music, that is, one music file corresponds to one piece of music, and the music file can include various files correlated with the music. For example, the music file may include at least one of a song name, singer information, lyrics text, year of production of the music, a playback time, or an audio file. However, the example of the present invention does not limit content included in the music file.

After the music file is acquired, in step 102, a music feature of the music file is generated based on the music file.

In some examples, the music feature may include at least one of a musical style, content of the lyrics, a feeling and a thought expressed by the music, or music rhythm.

For example, the musical style includes pop music that has memorable melody, upbeat rhythm, and is close to daily life, rock music that has powerful rhythm, heavy guitar sound, and rebellious spirit, classical music that has an elaborate structure and complicated composition, jazz music that is improvisation and has complicated rhythm, electronic music that mainly has electronic sound effects and has various styles and futuristic sense, folk music that is played back using simple musical instruments with earthy lyrics and has a rich sense of humanity, metal music which is fast-paced, has complicated drum beat and is sung by a radical vocalist, country music which is full of character of the southern part of the United States and has beautiful melody, and the like.

For example, the content of the lyrics includes delicate expression of feelings such as affection, friendship, and family love, deep insight of dream, growth, and life, observation and thinking for a social phenomenon and a historical event, vivid description of natural landscape and a daily life scene, expression and inheritance of cultural tradition and spirit of the age, and the like.

For example, the feeling expressed by the music includes various complicated feelings such as sweetness and romance of love, bittersweetness and bitterness, family warmth, thankfulness and anamnesis, joy of friendship and sadness of leaving, personal joy and rising feeling, loneliness and desolation, and further, pursuit of ideals, praise of nature, and speculation of life.

For example, the thought expressed by the music includes praise of love and beauty, pursuit of freedom and dream, criticism and reflection of real society, search for meaning and value of life, thinking of a relationship between human and nature, and the like.

For example, the music rhythm includes stable regular rhythm like rhythm of march, syncopation rhythm and dotted rhythm which are complicated and varied and provide a feeling of tension and dynamic change, rhythmical swing rhythm, accent rhythm having strong impact, various characteristic rhythm patterns formed by combinations of long and short sound such as triplet rhythm and 16th note rhythm, and further includes rhythm that embodies characteristics of various styles such as rumba rhythm and samba rhythm of Latin music, and complicated and varied rhythm of jazz music.

By generating the music features including multidimensional information based on the multidimensional information included in the music file in this manner, it is possible to further improve the matching degree between the image to be generated and the music file and express characteristics of the music from different perspectives through the image, which further enhances how the user auditorily feels the music through a visual sense of the image while the user is enjoying the music, so that the user experience is further improved.

In some examples, the music feature can be directly extracted from the music file, and for example, the music feature can be extracted through an artificial intelligence model or a musical element can be extracted from the music file, and a music feature can be generated based on the musical element.

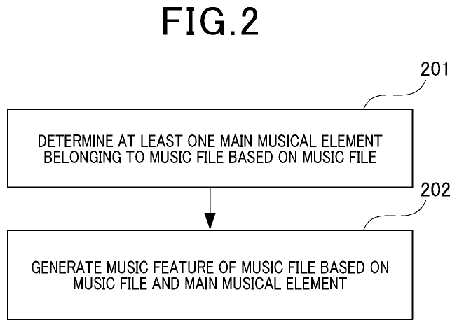

FIG. 2 is a block diagram for implementing the method in step 102 according to the example of the present invention. As indicated in FIG. 2, the method includes the following steps:
step 201: determine at least one main musical element belonging to the music file based on the music file; and
step 202: generate a music feature of the music file based on the music file and the main musical element.

By generating the music feature by determining the main musical element of the music file in this manner, the music feature can be comprehensively and accurately determined from various perspectives, which increases the matching degree between the image to be generated and the music file and further improves the user experience.

In some examples, a type of the musical element is determined in advance, and, for example, a plurality of musical elements that becomes candidates is determined based on publicly available data sets like MTT data sets. By this means, the musical elements can be comprehensively extracted.

In some examples, the type of the musical element includes various sound attributes, sound types, voice loudness, musical instruments, and the like, for example, male voice, female voice, animal sounds, solo, chorus, harmony, high pitch, low pitch, medium pitch, guitar, piano, drum, and the like.

In some examples, the music file is analyzed to acquire a plurality of musical elements, correlation between the music file and the plurality of musical elements is determined, at least one musical element for which the correlation satisfies a preset condition is selected from the plurality of musical elements, and the musical element can be set as a main musical element belonging to the music file. For example, at least one musical element for which the correlation exceeds a preset threshold is selected and set as a main musical element of the music file.

By finding a musical element having a strong correlation with the music file through analysis of the music file and using the musical element to generate an image as the main musical element of the music file in this manner, it is possible to further increase a matching degree between the image to be generated and the music file and further improve the user experience.

In some examples, step 201 and step 202 can be implemented through an artificial intelligence model.

For example, a main musical element is extracted using a trained music classifier model, and the music feature is generated. For example, a Music NN model is used to extract at least one main musical element belonging to the music, and a musical element having a large weight or having a distinctive characteristic is set as the main musical element of the music file. The weight described here can indicate correlation with the music. For example, the weight of each musical element or whether the characteristic is distinctive is indicated by luminance, and higher luminance indicates that the weight is larger, or the characteristic is more distinctive, that is, the correlation with the music is stronger. The musical elements of a preset number with the highest luminance are selected and can be set as the main musical elements of the music.

Further, the music feature can be generated also through a Music NN model. For example, the selected musical elements of the preset number are set as the main musical elements of the music file, and the music feature is generated based on the main musical elements.

For example, male singer, guitar, powerful rhythm, and drum set are determined as the main musical elements belonging to the music file, and a music feature: rock music is generated based on these main musical elements. Further, the music feature can be generated by combining other information within the music file. For example, the content of the lyrics is combined with the above-described main musical elements, that is, male singer, guitar, powerful rhythm, and drum set, and a music feature: expression of personality and freedom, rock music is generated based on these main musical elements.

In some examples, a type of the musical element can be determined based on selection or adjustment by the user, that is, a musical element desired by the user can be added or selected. For example, the user can select or adjust a musical element and a music feature during use. This makes it possible to make the image further match the user's preference and needs and eventually generate an image closer to the user's preference, so that the user experience is further improved.

For example, in a case where it is necessary to determine four main musical elements to generate a music feature, and, based on the music classifier model, four musical elements with the highest luminance are male singer, a high pitch, slow rhythm, piano, and pops, the musical element that ranks fifth in luminance is electronic, and the user prefers “electronic”, by replacing “pops” that ranks fourth with “electronic”, the four main musical elements can be formed. A music feature: tenor, lyric slow song, electronic music is generated based on the above-described four main musical elements. In the examples of the present invention, the number of the main musical elements and the number of the music features do not have to be limited and can be set in advance, or determined based on correction or selection by the user. As the number of the selected main musical elements and the number of music features are larger, an image to be formed based on the music features becomes closer to a sense of the music, which satisfies the personalized needs of the user and improves the user experience.

In some examples, a type of the music feature is determined in advance, and a plurality of music features that becomes candidates is determined based on publicly available data sets, for example, MTT data sets. By this means, the music features can be comprehensively extracted.

While in step 102, the music feature of the music file is generated based on the music file, the process can include forming a music feature library based on the type of the music feature determined in advance, performing analysis processing on an audio signal of the music file to acquire correlated feature information, matching the acquired correlated feature information with the music features within the music feature library, and acquiring the music feature of the music file.

In some examples, the type of the music feature is determined based on selection or adjustment by the user. In other words, the user can add or select a music feature desired by the user himself/herself. This makes it possible to generate an image closer to the user's preference and further improve the user experience.

After the music feature is generated, in step 103, the image theme and the visual template that match the music feature are determined.

For example, the determination includes determining the image theme that matches the musical style and/or the content of the lyrics and determining the visual template that matches at least one of the feeling and the thought expressed by the music or the music rhythm. This makes it possible to determine an appropriate image theme and visual template from a plurality of dimensions of the music, which further increases a matching degree between the image to be generated and the music.

In some examples, the image theme can include various styles of the image, and for example, includes a realistic style that faithfully reproduces reality, a fantastical fantasy style, a nostalgic retro-chic style, a simple and clear line art style, a flat illustration style in which emphasis is placed on two-dimensional vision, a highly three-dimensional (3D) illustration style, a characteristic psychedelic illustration style with bright colors and a unique pattern, a dynamic animation illustration style, and the like, and further, includes a technology style, an industrial style, a cartoon style, a watercolor style, a sketch style, an oil painting style, a constructive style, a picture book style, a Chinese-style picture book style, a cyberpunk style, a pattern style, an ink brush painting style, and the like.

In some examples, the visual template can include various dynamic effects of the image, for example, a panning effect that causes position movement of the element, a rotation effect of rotating around a specific point, a scaling effect of changing a size, a fade-in/fade-out effect that causes change in transparency, an expanding/folding effect of expanding or folding with a specific shape or route, a blinking effect that simulates change of light and shadow, a bouncing effect that expresses elastic movement of an object, a transition effect in which elements mutually transit, a focus/defocus effect that expresses change between blur and sharpness of the image, and the like.

In step 103, how to determine the image theme (for example, the image style) that matches the music feature will be exemplified as follows:

In transmission of an atmosphere and a feeling, the atmosphere and the feeling are made to match each other to bring harmonized and sensory experience having a sense of unity to people, for example, for the image style that matches the musical style, a cyberpunk-style image with a sense of technology and a dynamic line can be made to match electronic music with uplifting and fast rhythm; for classical music with beautiful melody, a classical oil-painting-style image having delicate brush strokes and elegant color tone is preferably made to match, for a folk song with sad emotion, a realistic illustration-style image that draws a lonely screen with dark color tone can be made to coordinate, for music under the theme of nature, a realistic picture-style image that expresses natural scenery can be selected, and for music with strong ethnic characteristics, an ethnic image with elements and color of the corresponding ethnic group can be made to match.

Concerning the image style that matches the feeling expressed by the music, for example, to a futuristic and rebelling feeling, an image style with cyberpunk-style high-saturation color, a technology element, a dystopia-like scene, and the like, is made to correspond, to a deep, elegant, and story-rich feeling, an oil painting-style image style with delicate brush strokes, which is colorful, realistic or true to nature is made to correspond, and to a rational feeling with a sense of innovation and a leading edge, a technology-style image style with characteristics of a simple line, metallic texture, cool color tone, and the like, is made to correspond, thereby the music and the image emotionally and visually reflect each other and cause an effect of enhancing each other.

Concerning the image style that matches the thought expressed by the music, for example, in a case where the music expresses a thought of thinking-over about conflict between future technology and humanity, a cyberpunk-style image style with a technology element, a dystopia atmosphere, and strong visual conflict can be made to correspond, in a case where the music conveys deep thinking for a feeling, history, humanism, and the like, an oil painting-style image style with rich texture of brush strokes, excellent color expression, and realistic or romantic expression, can be made to match, and in a case where the music embodies a thought of praise for development of science technology, search for unknown, and the like, a technology-style image style with a simple and modern line, metallic texture, cool color tone, and the like, can be made to coordinate, thereby a high match between the thought of the music and the image style can be achieved in sense and visual expression.

Concerning the image style that matches the music rhythm, for example, in a case where the music rhythm is powerful and fast, a dynamic image style with powerful visual impact, for example, a cyberpunk style can be made to match, and a screen is filled with a light beam that moves at a high speed, blinking neon, and striking color contrast is made to coordinate with powerful rhythm of the music. On the other hand, the music with calm and stable rhythm is preferably combined with an image having a style such as a landscape work of realism, and quiet nature scenery in a screen matches the stable rhythm of the music, which brings calmness and peace of mind to people.

Concerning the image style that matches the content of the lyrics of the music, for example, in a case where the content of the lyrics of the music deals with a theme such as the future world, conflict of technologies, and conflict of humanity, an image style with cyberpunk-style high contrast of light and shadow, neon color, fusion of machine and human body, and the like, can be made to correspond, and in a case where the lyrics are filled with a humanistic feeling, history story, and delicate emotions, an oil painting-style image style with rich brush strokes and a deep color hierarchy can be made to coordinate. On the other hand, in a case where the lyrics focus on content of an innovative science and technology, space exploration, a cutting edge technology, and the like, a technology-style image style based on cool color such as blue, with a simple shape and metallic gloss is preferably made to match. Thereby, unity between the lyrics and the image can be achieved by expression of idea and the atmosphere.

How the visual template (for example, a dynamic effect) that matches the music feature is determined in step 103 will be exemplified below:

Concerning the dynamic effect that matches the musical style, for example, to uplifting and passionate rock music, a dynamic effect such as rapid change of light and shadow in the image, blinking of strong color, and high-speed movement of the element can be made to correspond, calm beautiful classical music is preferably combined with a dynamic effect such as soft gradation like flow of water in the image, slow movement of the element, and fade-in/fade-out, and vibrant electronic music can be made to coordinate with a dynamic effect such as frequent hopping of a pixel in the image, deformation and reconfiguration of a figure, and blinking of cool special effects, thereby perfect unity between the music and image can be achieved by the rhythm and the atmosphere.

Concerning the dynamic effect that matches the feeling expressed by the music, for example, a bright and joyful feeling of music can be made to correspond to a dynamic effect such as light blinking of the element in the image, quick hopping, and change in brightness of color, and a feeling of music with sadness and depression is preferably embodied with a dynamic effect such as slow fade-in/fade-out in the image, gradual disappearance of the element, and gradation of dark color. On the other hand, a passionate and uplifting feeling of music can be made to coordinate with a dynamic effect such as strong impact of light and shadow in the image, intense movement of the element, and high-speed switching of high contrast of color. This produces an effect that the feeling of the music and the dynamic effect of the image can enhance each other in transmission of the emotion.

Concerning the dynamic effect that matches the thought expressed by the music, for example, in a case where the music expresses a thought such as longing and search for future, a dynamic effect such as an aspect in which the element quickly comes and goes in the image, deformation and reconfiguration of the element, and blinking of light and shadow with a sense of technology can be made to correspond, in a case where the music conveys the thinking on transition of history and flow of time, the image is expressed with a dynamic effect such as slow discoloration of the element, and alternate emergence and disappearance of the elements, and in a case where the music expresses the thought of pursuit of freedom, the image can be made to coordinate with a dynamic effect such as free traveling of the element and a trajectory of unconstrained movement, thereby the thought of the music and the dynamic effect of the image can be made to match each other in sense.

Concerning the dynamic effect that matches the music rhythm, for example, to music with light and powerful rhythm, a dynamic effect such as quick blinking of the element in the image, highly frequent jumping, and drastic displacement and change can be made to correspond, and music with calm and stable rhythm is preferably combined with a dynamic effect such as slow movement of the element in the image, soft gradation, and smooth fade-in/fade-out. Further, music which is varied and has hierarchies can be made to match a dynamic effect such as switching of speed of movement of the element appearing with different sections of a song, complicated change of light and shadow, and various combinational conversions in the image. Thereby, resonance between the music rhythm and the dynamic effect of the image can be achieved.

Concerning the dynamic effect that matches the content of the lyrics of the music, for example, in a case where the content of the lyrics of the music relates to passionate chase and adventure, a dynamic effect such as high-speed movement and crashing of the elements in the image, can be made to correspond, in a case where the lyrics express a delicate feeling such as desolation and farewell, the image is made to coordinate with a dynamic effect such as slow drifting and gradual disappearance of the element, and in a case where the lyrics express a fantasy scene, the image can express a dynamic effect such as random deformation of the element and fantastical blinking, thereby the content of the lyrics and the dynamic effect of the image can be made to match each other in a feeling and artistic idea.

Further, after the music feature is generated, in step 104, the image feature related to the music feature is determined.

In the example of the present invention, execution order of step 104 and step 103 is not limited, and for example, step 104 and step 103 may be executed at the same time or may be sequentially executed.

In some examples, the image feature may be referred to as a visual feature or an image visual feature.

In some examples, the image feature related to the music feature can be acquired in various ways, and, for example, an image feature for which correlation with the music feature satisfies a preset condition (for example, the correlation exceeds a preset threshold, that is, an image feature having strong relevance with the music feature) can be extracted from an image database. By extracting the image feature for which the correlation satisfies the preset condition from the image database containing a large amount of image features and generating an image in this manner, it is possible to improve abundance of the image to be generated and increase a matching degree with the music.

Further, the image feature can be determined through an artificial intelligence model.

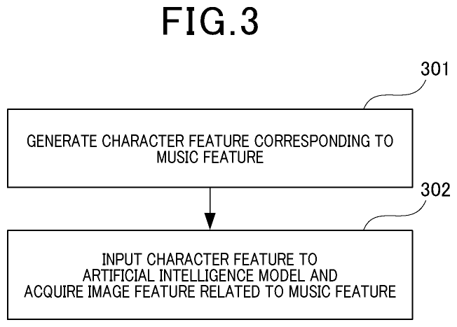

FIG. 3 is a block diagram for implementing the method in step 104 according to the example of the present invention. As indicated in FIG. 3, the method includes the following steps:
step 301: generate a character feature corresponding to the music feature; and
step 302: input the character feature to an artificial intelligence model and acquire an image feature related to the music feature.

In this manner, the image feature related to the music feature can be efficiently acquired through a model for acquiring the image feature based on the character feature, so that efficiency of image generation is further improved.

For example, in step 301, the music feature can be converted into the corresponding character feature, and in step 302, the related image feature can be output based on text of the music feature using a CLIP model. The correlated technique can be referred to for specific content of the CLIP model, and thus, description will not be repeated here.

In some examples, the image feature includes, for example, a specific person, animal, thing, environment, scene, and the like.

The image feature associated with the music feature is, for example, as described below.

Classical music can be associated with a thing that makes people feel history, like an elegant pose of a person, antique, an environment of magnificent classical architecture, and a scene of a royal ball.

Rock music can be associated with a passionate and individual character, a powerful animal like a lion, an exaggerated shaped thing, an industrial environment with highly metallic feel, and a bustling scene of a large-scale music festival.

Ethnic music can be associated with people with clothes and accessories having ethnic characteristics, an animal that represents a region like a Mongol swift horse, traditional ethnic handcrafts, a natural environment unique to that region, and scenes of ethnic activities.

The image feature related to the feeling expressed by the music is, for example, as follows.

A joyful feeling can be associated with a smiling person, an active animal like a jumping rabbit, a brilliant colored thing, a natural environment filled with sunlight, and a scene of fun gathering.

A feeling of sadness can be associated with a person with melancholic expression, a lonely animal like a goose left alone, an old and damaged thing, a somber and depressing environment, and an empty and desolate scene.

An uplifting feeling is preferably combined with a powerful person with firm expression, a group of animals that are vigorously running, a thing associated with powerful power like rocket fire, an environment of flash of lightning and thunder, and an intense battle scene.

The image feature related to the thought expressed by the music is, for example, as follows.

The thought of pursuit of freedom can be expressed with a person walking alone on the vast land, for example, a traveler who walks in the illimitable desert, or an animal such as a bird that is hovering in the sky while spreading its wings, or a thing such as a dandelion in the wind, and can be expressed in combination with an environment such as a vast grassy plain and an ocean, and a scene in which a bird is freely flying in the sky, and a sailboat crosses the sea.

The thought of advocating for peace can be expressed with people with different skin colors smiling and holding hands, a screen with a leading character of an animal such as a dove holding a branch of olive in its mouth in combination with a thing such as a carving of a dove, with background of an environment such as quiet and peaceful townscape and a leafy park, or a scene in which people observe a moment of silence in front of a peace monument, or representatives from various countries shake hands and make piece, which conveys a theme of peace.

The image feature related to the music rhythm is, for example, as follows.

Fast and powerful rhythm is preferably combined with a moving person such as a moment in which a sprinter runs at full speed, a scene of a fast-running animal like a cheetah, and a thing such as a speeding racing car, in a dynamic environment such as a racing circuit and an athletic field, and a scene of intense sports and a carnival party, which are made to match fast and powerful music rhythm with fast-paced change of screens.

Slow and gentle rhythm can be associated with a person with affectionate expression like a mother who softly rocks a child in a cradle, an animal such as a cat quietly lying down, a thing such as a vase by the window, an environment such as a warm bedroom and a quiet garden, and a poised scene such as the elderly walking in the sunset, and a couple strolling the beach, and the movement and the atmosphere of the image are made to match the slow and gentle rhythm.

Varied rhythm can be associated with content having rich script and dynamic change, including, for example, a screen of a person in which a performer exhibits highly difficult acrobatics, a scene of an animal in which a monkey bounces around the woods, a thing such as a firework that constantly changes its shape, an environment such as a fantastical dream world, and switch between various thrilling scenes in an adventure movie and calm and gentle scenes, and different movement in the image and ups and downs of the script are made to match change of the music rhythm.

The image feature related to the content of the lyrics of the music is, for example, as follows.

In a case where the lyrics express a story of a person, for example, if the lyrics depict a brave explorer, the image can include a character who is wearing a rucksack, holding the map in his hand, standing on the summit and gazing in the distance, with an animal such as a loyal hunting dog accompanying him, and a thing such as a pickel for climbing placed nearby, on the background of an environment with grand and rugged mountains, and may also include the explorer crossing the valley and camping in a snowfield.

In a case where the lyrics relate to an animal, for example, if the lyrics are “a swift horse is running through the grassland”, the image certainly includes one horse or a group of horses running through a vast grassland, may include a person who is a cattleman keeping animals on a horse, and a thing such as a yurt in the grassland, and includes an environment of grassland under blue sky and white clouds, and a scene in which the swift horse is drinking water.

In a case where the lyrics mention a specific thing, for example, if the lyrics include “old castle”, the image mainly includes a castle, may include a person such as a tourist stopping in front of the castle, an animal like a crow on the castle, a thing such as a water moat that surrounds the castle and a suspension bridge, an environment of an ominous or stately castle, and may include an imaginary scene of a medieval ball in the castle.

In a case where the lyrics depict an atmosphere of the environment, for example, if the lyrics include “a quiet forest path”, the image expresses a path winding in the forest, and may include a person such as an elderly person who walks along the path and a child who picks mushrooms, an animal such as a squirrel in the woods, things such as roadside mushrooms and fallen leaves, an environment of the quiet forest that is densely wooded, and a scene in which sunlight filtering through the trees shines down on the path.

In a case where a specific scene is set in the lyrics, for example, in a case where the lyrics mention “a busy station”, the image includes a scene of a station, people such as passengers in a hurry, animals such as sparrows that sometimes fly over a platform, things such as trains and luggage trolleys, an environment of a station crowded with people, and a scene in which the train arrives, and people wave their hands and say farewell.

In some examples, in a case where one piece of music includes a plurality of music features, by setting matching priority for the plurality of music features, an image theme (for example, an image style) and a visual template (for example, a dynamic effect) corresponding to the music feature with the highest priority, and the image feature can be made to match. Further, the setting of the priority may be set in advance or may be set or adjusted by the user. In this manner, in a case where there is a plurality of music features of the music file to be generated, the image theme and the visual template that match the music feature with the highest priority, and the image feature are determined in accordance with the priority, thereby the image to be generated can be made to match the music feature with the highest priority.

After the image theme and the visual template that match the music feature, and the image feature related to the music feature are determined, in step 105, the image that matches the music file is generated based on the image theme, the visual template, and the image feature.

As described above, the determined image theme matches the music feature, the visual template matches the music feature, and the image feature is related to the music feature, and thus, the whole of the image, part of the image, a display format of the image, and the like, of the image to be generated can be made to match the music feature in visual attributes from different dimensions. By this means, if the generated image is displayed at the same time as the music being played back, the user can intuitively feel the characteristics and sense of the music from both visual and auditory perspectives, which easily attracts sympathy and effectively improves the user experience.

In some examples, the image to be generated is a moving image. However, the image to be generated may be a static image, and the example of the present invention does not limit the image to be generated.

In some examples, the image can be generated based on an artificial intelligence technology, and, for example, the image that matches the music file is generated based on a generative artificial intelligence model. This makes it possible to efficiently generate an image with a high matching degree.

For example, the image is generated based on a GAN model. Further, for example, the image is generated stepwise based on a Style GAN model and the CLIP model. The correlated technique can be referred to for specific content of the GAN model, the Style GAN model, and the CLIP model, and thus, description will not be repeated here.

Further, a graphic rendering technique can be used to generate the image.

In some examples, as indicated in FIG. 1, after the image that matches the music file is generated, the method may further include the following step:
step 106: play back music corresponding to the music file and display the generated image in synchronization with the music.

By the image that matches the music being displayed at the same time as the music being played back in this manner, the user can feel the music and the image with a high matching degree from both auditory and visual senses in synchronization with each other, so that the user experience is improved.

In some examples, step 101 to step 105 may be executed on a cloud, that is, on a network, and step 106 may be executed on a local terminal, or step 101 to step 106 may be executed on a local terminal. The example of the present invention does not limit a subject that executes these steps.

In some examples, the generated image and a music playback widget can be arranged in parallel on a music playback interface, and, for example, the image is displayed in an upper portion, and the music playback widget is displayed in a lower portion, or the image is displayed in a lower portion, and the music playback widget is displayed in an upper portion, or the image is displayed in a left portion, and the music playback widget is displayed in a right portion, or the image is displayed in a right portion, and the music playback widget is displayed in a left portion. Further, the image can be arranged to surround the playback widget. The example of the present invention does not limit a positional relationship between the image to be displayed and the music playback widget.

In some examples, content such as a song name, a singer, and lyrics can be displayed on the music playback interface, and in a similar manner, the example of the present invention does not limit a positional relationship among the song name, the singer, the lyrics, the image, and the music playback widget.

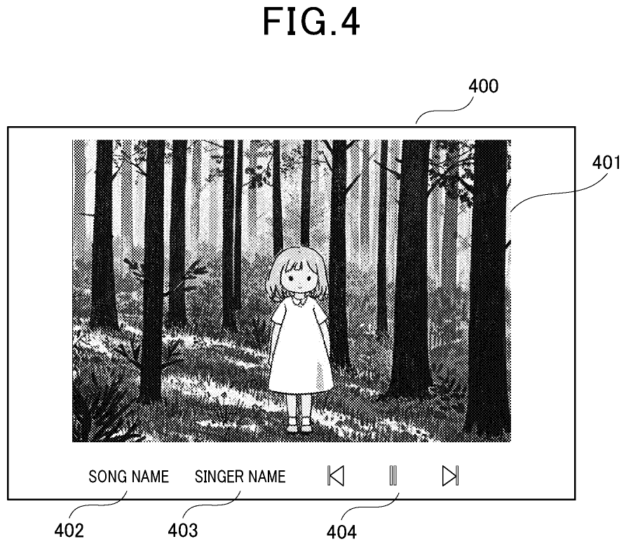

FIG. 4 is a block diagram of the music playback interface according to the example of the present invention. As illustrated in FIG. 4, a generated image 401 that matches the music is displayed in an upper portion of the music playback interface 400, and a song name 402, a singer name 403, a playback widget 404, and the like, are displayed under the image 401.

Note that the music playback interface illustrated in FIG. 4 is merely one example, and other layouts can be employed, and the lyrics and other widgets such as, for example, a widget of an image parameter which will be described later, can be displayed.

In some examples, the generated image that matches the music is not a fixed and unchanged image, and the image can be dynamically updated during a playback process of the music.

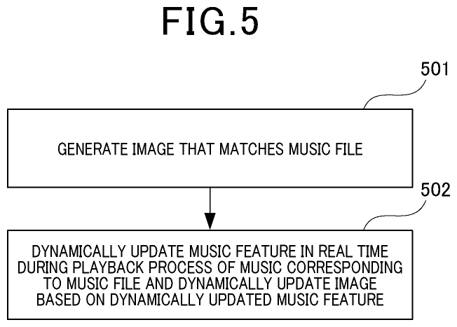

FIG. 5 is another block diagram of the multimedia processing method according to the example of the present invention. As indicated in FIG. 5, the method includes the following steps:
step 501: generate an image that matches the music file; and
step 502: dynamically update the music feature in real time during a playback process of music corresponding to the music file and dynamically update the image based on the dynamically updated music feature.

In step 501, as a method for generating the image that matches the music file, the method described in the above-described steps 101 to 105 can be employed, but the method is not limited to the method described in the above-described steps 101 to 105, and the image that matches the music file can be generated in any other ways.

In step 502, the music feature is dynamically updated in real time during the playback process of the music corresponding to the music file, and the image is dynamically updated based on the dynamically updated music feature.

By dynamically updating the image during the playback process of the music in this manner, it is possible to present the image dynamically related to a progress of the song, climax, the expressed feeling, and the like, and thus, the user can feel the song and change of the image in synchronization with each other, so that the user experience is further improved.

In some examples, at least one of a display parameter, display content, or a display format of the image can be dynamically updated based on at least one of a playback time, a structure, rhythm, a volume, or change of a feeling of the music. By a display parameter such as luminance and chroma of the image, display content, or a display format (for example, a dynamic effect) being dynamically updated based on the progress, a climax portion, change of the feeling, and the like, of the music in this manner, a display effect that the image and the music change in synchronization with each other is further improved.

For example, in a case where “an old castle” is depicted in an opening of the lyrics of the music, the music feature includes content of the castle, the generated image mainly includes a castle, and as the music is played back, a “quiet forest path” appears in the lyrics, and thus, the music feature is updated to content including the forest, and the image is automatically updated to a path winding in the forest. It is thereby possible to significantly improve a way of intuitive feeling by the user of the image and the music matching each other and changing in synchronization with each other, so that the user experience is further improved.

Further, for example, while rhythm is relatively gentle in a verse portion of the music, the image includes a cat quietly lying down. If a hook is played back, the music reaches the climax, and as the music rhythm becomes faster and more passionate, the sleeping cat in the image changes to a cheetah running at a terrific speed, which allows the user to more intuitively and strongly feel change of the music rhythm.

Further, for example, if the music reaches the climax portion, a person who has remained still in the image so far starts dancing, which allows the user to more intuitively and strongly feel arrival of the climax portion of the music.

In some examples, it is possible to receive a voice command for adjusting the music file and/or the image, generate a recommended adjustment plan for the music file and/or the image, and update the music file and/or the image after obtaining confirmation or correction by the user. In this manner, even if the user does not make specific adjustment setting, by the recommended adjustment plan being presented based on the voice command of the user, the user can make confirmation or correction, and the plan confirmed by the user can be made closer to the user needs, so that the user feeling of experience is further improved.

For example, in a case where the user issues a voice command of “want to listen little melancholic music”, after the voice command of the user is received and analyzed, it is possible to generate an “image adjustment plan and/or music adjustment plan” that matches a keyword of “melancholic”, confirm the generated “image adjustment plan and/or music adjustment plan” with the user through a music interaction and put into action after being confirmed by the user.

The following is one exemplary embodiment of the multimedia processing method described above and includes the following processing.

1. Processing of automatically analyzing the musical style and the element, including the following:
audio decode: receive and decode an audio signal stream of a song and extract an audio signal available for analysis;
feature extraction: extract important features such as rhythm, sound tone, harmony, and timbre using a digital signal processing technique;
machine learning analysis: analyze these features using a trained machine learning model (for example, a neural network), determine a style and a musical element of the song, and classify the song as a style/category defined in advance, for example, pops, rock, electronic, and the like; and
generation of music feature: create music feature data including the style and the musical element and eventually use the music feature data for subsequent image generation and display of a user interface.

2. Processing of generating an image that matches the song in real time, including the flowing:
reception of music feature data: receive the music feature data from a module that automatically analyzes the style and the musical element of the song;
content planning: select one or a plurality of image themes based on the music feature data, these themes being to match the style and the musical element of the song or to match the music feature data of the song;
template selection: select a template that matches the style and the musical element of the song or a template that matches the music feature from a plurality of types of visual templates provided in advance;
image feature selection: select an image feature that matches the style and the musical element of the song or select an image feature that matches the music feature from the image database;
image synthesis: generate an image based on the visual template, the image theme, and the image feature by utilizing a graphic rendering technique, this stage may accompany color adjustment, deformation, application of texture, and the like; and
real time adjustment: dynamically adjust details of the image based on a length and a structure of the song and reflect ups and downs of the song.

3. Processing of updating the image in real time in response to dynamic change of the song, including the following:
dynamic monitoring: monitor an audio output of the song in real time and capture a volume, rhythm, and other dynamic changes;
feeling analysis: predict feeling tendency of a current song portion based on the dynamic change using a feeling analysis algorithm;
image adjustment: adjust an image parameter such as color, luminance and chroma of the image based on a result of the feeling analysis to express the corresponding feeling; and
feedback loop: continue to adjust the image so that emotion of the image and the audio matches during the playback process of the song.

4. Processing corresponding to selection of various visual styles, including the following:
style definition: define and develop various visual styles including, but not limited to, an abstract style, a modern style, a retro style, a futuristic style, and the like,
user setting: enable selection of one or a plurality of visual styles preferred by the user in settings of an application;
style adaptation: adjust parameters in an image generation algorithm based on the style selected by the user so that the image to be generated matches the style preferred by the user; and
dynamic application: dynamically update the image based on the style selected by the user when the song is played back and provide personalized visual experience.

In some examples, the user can adjust the music through the generated image, that is, it is possible to put a tuning function into use based on the image.

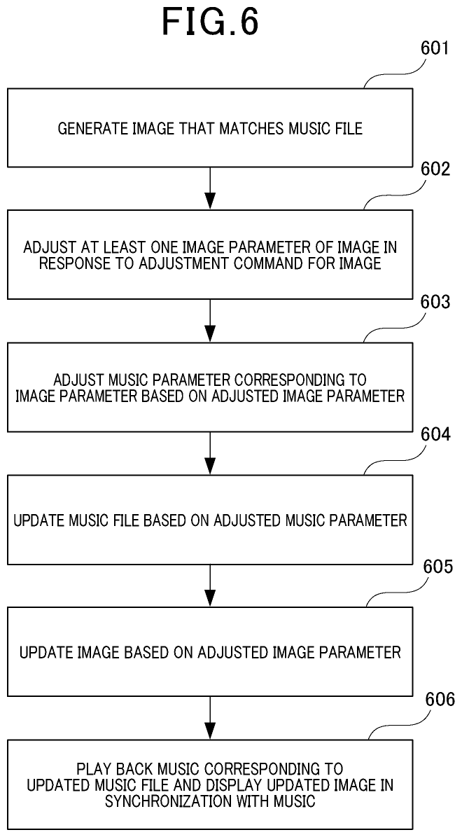

FIG. 6 is another block diagram of the multimedia processing method according to the example of the present invention. As indicated in FIG. 6, the method includes the following steps:
step 601: generate an image that matches the music file;
step 602: adjust at least one image parameter of the image in response to an adjustment command for the image;
step 603: adjust a music parameter corresponding to the image parameter based on the adjusted image parameter; and
step 604: update the music file based on the adjusted music parameter.

In step 601, as a method for generating the image that matches the music file, the method described in the above-described steps 101 to 105 can be employed, or the method is not limited to the method described in the above-described steps 101 to 105, and the image that matches the music file can be generated in any other ways.

By adjusting the image parameter of the image that matches the music by utilizing relevance between the image parameter and the music parameter through steps 602 to 604, the user can correspondingly adjust the related music parameter, which enables correction on the music, that is, enables a tuning function based on image adjustment. Thus, the user can put a tuning function into use in an intuitive, simple, and innovative way, which improves fun of use and usability, and improves the user experience.

In some examples, the adjustment command is generated based on the voice command and/or operation on the displayed widget. This allows the user to adjust the image and/or the music in various ways, which improves usability for the user.

For example, in step 602, the adjustment command for the image can be generated based on the voice command of the user, or the adjustment command for the image can be also generated based on adjustment operation on the image parameter by the user. The adjustment command for the image is generated in various ways such as voice of the user and user operation, which improves usability for the user and further improves convenience of use.

In some examples, the adjustment operation on the image parameter by the user includes adjustment of a weight of the image parameter by the user operating the displayed widget of the image parameter. In response to this, in step 603, a weight of the music parameter related to the image parameter is adjusted based on change of the adjusted weight of the image parameter, thereby, in step 604, the music file is updated based on the adjusted music parameter.

For example, the weight of the image parameter indicates a degree of influence of the image parameter on the image, and the weight of the music parameter indicates a degree of influence of the music parameter on the music.

By adjusting change of the weight of the image parameter based on the operation on the displayed widget of the image parameter thereby adjusting the weight of the related music parameter, corresponding adjustment of the music parameter can be accurately and quickly achieved.

Alternatively, it is possible to directly adjust specific numerical values of the image parameter and the music parameter. For example, the adjustment operation on the image parameter by the user includes adjustment of a specific numerical value of the image parameter by the user operating the displayed widget of the image parameter. Correspondingly, in step 603, a specific numerical value of the music parameter related to the image parameter is adjusted based on change of the adjusted specific numerical value of the image parameter, thereby, in step 604, the music file is updated based on the adjusted music parameter.

In some examples, a correspondence relationship between the image parameter and the music parameter is determined in advance. By this means, the music adjustment based on the image adjustment can be achieved in a simple way.

In some examples, a correspondence relationship between the image parameter and the music parameter is determined based on relevance between the image parameter and the image feature, relevance between the image feature and the music feature, and relevance between the music feature and the music parameter.

For example, the image feature related to the image parameter changes by adjustment of the image parameter, the music feature related to the image feature changes by change of the image feature, and further, the music parameter related to the music feature changes, thereby, updating of the music file is implemented.

As a result of a correspondence relationship between the adjusted image parameter and the adjusted music parameter being provided based on the relevance among the image parameter, the image feature, the music feature, and the music parameter, a correspondence relationship between the image parameter and the music parameter can be established in a deeper level and from more dimensions, which is advantageous in achieving complicated and advanced adjustment for the image and the music.

In some examples, updating of the music file can be achieved by utilizing an artificial intelligence technique, and, for example, adjustment of the music parameter can be applied to different pieces of music by utilizing a style transition model. Further, for example, synchronization between adjustment of the image parameter and adjustment of the music parameter is achieved using a multimodal alignment technique.

In some examples, widgets of a plurality of image parameters can be displayed on the displayed image in a superimposed manner, or widgets of a plurality of image parameters can be displayed around the image.

The user can adjust a plurality of image parameters by various kinds of operation, for example, adjusts the image parameters by operation such as sliding, scrolling, and clicking, and, for example, adjusts the weights of the image parameters.

By the weight of the corresponding image parameter being adjusted based on the displayed widget in this manner, the image parameter can be easily adjusted.

In some examples, the image parameter may include various parameters correlated with the image, and, for example, the image parameter includes at least one of luminance, contrast, chroma, an image style, color, a size, main content or a dynamic effect of the image.

In some examples, the music parameter may include various parameters correlated with the music. For example, the music parameter can be indicated with an equalizer, and adjustment and change of the music parameter can be indicated as change of an equalizer curve. Of course, it is also possible to employ other expression methods.

For example, the music parameter includes at least one of a pitch, timbre, sound tone, a volume, a musical style, a reverb, a delay, a gain, a music phase, a crossover sound pressure, a power amplifier channel, or rhythm of the music.

In this manner, multidimensional music parameters can be associated through multidimensional image parameters, so that it is possible to flexibly and comprehensively adjust the music and the image that matches the music.

In step 604, the music file is updated based on the adjusted music parameter. For example, change of the music parameter is expressed with change of the equalizer curve, and an audio signal of the music is processed based on the adjusted equalizer curve, thereby the updated music file can be acquired.

Note that in a case where the updated music file is played back, it can be assumed that the processed audio signal stream is played back. Of course, it is also possible to employ other methods.

In some examples, the image parameter and the music parameter are associated with each other in advance, and a rule for association in advance may be set in advance or may be set or adjusted by the user. In other words, the image parameter corresponds to the music parameter, and a correspondence relationship may be set in advance or may be set or adjusted by the user.

For example, Table 1 indicates a correspondence relationship between the image parameter and the music parameter. However, this is merely an example, and two types of parameters may be associated with each other using other association methods, or some of the image parameters and the music parameters indicated in Table 1 can be used, or other image parameters and music parameters not indicated in Table 1 can be included.

TABLE 1
Correspondence relationship between
image parameter and music parameter

| Number | Image parameter | Music parameter |
|---|---|---|
| 1 | Luminance | Pitch |
| 2 | Chroma | Timbre |
| 3 | Softness | Sound tone |
| 4 | Contrast | Reverb |
| 5 | Main content | Delay |
| 6 | Dynamic effect | Rhythm |
| 7 | Image style | Musical style |
| 8 | Theme image style | EQ style |
| . . . | . . . | . . . |

In some examples, it is also possible to display explanatory information regarding relevance between the image parameter and the music parameter, and, for example, the explanatory information is displayed using a chart as indicated in Table 1, or by a widget of the corresponding image parameter being clicked, the correlated explanatory information is displayed as a pop-up. This allows the user to easily understand the widget of the image parameter and easily adjust the music using this.

In some examples, if the weight or the numerical value of the image parameter is adjusted to be high, the weight or the numerical value of the music parameter related to the image parameter is also adjusted to be high correspondingly, and if the weight or the numerical value of the image parameter is adjusted to be low, the weight or the numerical value of the music parameter related to the image parameter is also adjusted to be low correspondingly. An adjustment width of the music parameter may be the same as an adjustment width of the image parameter, or adjustment ratios of the both may be set in advance.

In some examples, as indicated in FIG. 6, the method can further include the following steps:
step 605: update the image based on the adjusted image parameter; and
step 606: play back the music corresponding to the updated music file and display the updated image in synchronization with the music.

This allows the user to intuitively feel feedback of the adjustment effect from both auditory and visual perspectives.

Step 605 and step 606 in the present method are examples, and the order of step 605 and step 606 is not limited, and step 605 and step 606 may be performed at the same time or may be sequentially performed.

In some examples, the method further includes a step of generating and displaying a recommended adjustment plan correlated with the image and/or the music based on an analysis result of the collected user data.

By this means, it is possible to provide a recommended adjustment plan based on popularity and trend based on analysis of big data, so that it is possible to assist the user to quickly find an adjustment plan that matches the user's preference, which further improves the user experience.

The following is one exemplary embodiment of the multimedia processing method described above and include the following processing.

1. Processing of providing a user-friendly adjustment interface, including the following:
interface design: create an intuitive and user-friendly interface to allow the user to easily adjust the image parameter;
visualized element: indicate the image parameter and the weight of the image parameter using visualized elements such as a chart, a slider, and a button;
tag and prompt: add a clear tag and prompt information to each of the adjustment widgets so that the user can understand the function;
interactive feedback: secure information so that immediate visual feedback such as change of the color and update of the numerical value can be obtained every time the change is made by interface operation by the user; and
layout optimization: optimize layout of the interface based on results of user examination and a user experience test so as to make the layout match the habit and intuition of the user.

2. Processing of giving a feedback of the adjustment result in real time, including the following:
audio processing: receive adjustment by the user and apply the adjustment to an audio signal and generate the adjusted sound effect in real time;
sound playback: transmit the adjusted audio signal stream to a speaker or other output devices so that the user can listen to the feedback in real time;
visual feedback: display the weight of the parameter after adjustment on the user interface so that the user can intuitively grasp the adjustment result; and
dynamic adjustment: continuously update the audio and the visual feedback if the user continues to adjust the image parameter, and reflect the latest adjustment result.

3. Processing of providing a recommended adjustment plan based on popularity and trend, including the following:
data analysis: collect and analyze a large amount of user data including an adjustment plan and preference;
pattern identification: identify a typical adjustment pattern and trend using a data mining technique;
recommendation algorithm: develop a recommendation algorithm based on the identified adjustment pattern and trend and provide the personalized adjustment plan to the user;
recommendation display: display the recommended adjustment plan on the user interface to assist the user to quickly find the adjustment plan that matches the user's preference; and
user feedback: collect the feedback of the user with respect to the recommended adjustment plan and utilize the feedback to continuously improve accuracy and effectiveness of the recommendation algorithm.

In some examples, it is possible to display a music tag corresponding to the music feature and update the music tag during the playback process of the music.

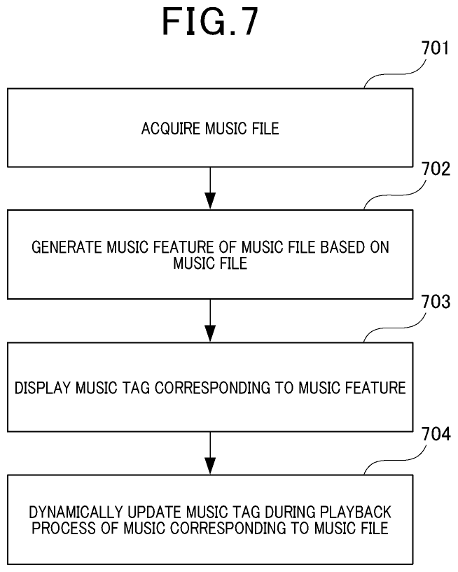

FIG. 7 is another block diagram of the multimedia processing method according to the example of the present invention. As indicated in FIG. 7, the method includes the following steps:
step 701: acquire the music file;
step 702: generate the music feature of the music file based on the music file;
step 703: display the music tag corresponding to the music feature; and
step 704: dynamically update the music tag during the playback process of the music corresponding to the music file.

By the music tag being dynamically updated based on the playback of the music in this manner, the user can intuitively feel change of the music feature, so that the user experience is further improved.

In some examples, step 701 and step 702 can be specifically performed with reference to step 101 and step 102, or the music file can be acquired and the music feature can be generated in any other ways. Further, the method indicated in FIG. 7 can be used in combination with the method indicated in FIG. 1 and/or the method indicated in FIG. 6, and this is not limited by the example of the present invention.

In some examples, the music tag corresponding to the music feature can include a musical element tag, a musical style tag, and a feeling tag expressed by the music.

For example, the musical element includes sound of a musical instrument, sound of wind, sound of rain, birdcalls, sound of waves, and the like.

For example, the tag of the musical style includes tags of pop music, rock music, classical music, jazz music, electronic music, folk music, metallic music, country music, and the like.

For example, the feeling tag expressed by the music includes feeling tags of sweetness, romance, nostalgia, bitterness, sorrow, warmth, thankfulness, anamnesis, joy, sadness of leaving, rising feeling, solitude, loneliness, anger, rebelliousness, and the like.

The following is one exemplary embodiment of the multimedia processing method described above and includes the following processing.

1. Processing of identifying a main sound element in the song and tagging the sound element, including the following:
audio analysis: receive an audio input of the song and extract information regarding a frequency, a duration, and timbre using a spectral analysis tool;
feature extraction: extract important features such as, for example, a harmonic structure, and attack and decay characteristics, which are helpful to distinguish different sound elements (or also referred to as musical elements);
classification by machine learning: analyze the extracted features by utilizing a trained machine learning model (for example, a convolutional neural network or a generative adversarial network) to identify a main sound element in the song;
generation of tag: create a tag including a name of the detected sound element based on an output of the machine learning model; and
display of tag: display the generated tag of the sound element on the user interface, update in real time and reflect change of the sound element in the song.

2. Processing of identifying a style of the song and an emotion tag and performing tagging, including the following:
audio processing: perform audio analysis of the song and extract important features such as rhythm, sound tone, and a degree of harmony;
music analysis: determine tonality, chord progression, and melody line of the song through analysis based on music theory and predict a style and a feeling;
style matching: perform matching using a musical style database provided in advance and identify a main style category to which the song belongs;
feeling analysis: analyze emotional color of the song such as, for example, joy, sorrow, rising feeling, and relaxing by utilizing an emotion identification algorithm; and
display of tag: display the identified style and the emotion tag on the user interface to ensure that these accurately reflect auditory experience of the user.

3. Processing of updating display of the tag in real time, including the following:
dynamic monitoring: continuously monitor change of the audio signal stream and capture all of a structure of the song and dynamic updating;
adjustment of tag: adjust the tag generated before and perform updating based on the real time analysis result of the audio signal stream;
synchronization of user interface: ensure that display of the tag on the user interface is in synchronization with a current state of the song so that accurate information is quickly provided; and
feedback mechanism: in a case where change of a new musical instrument or a style is detected, immediately give a feedback to the user interface and update content of the tag.

4. Processing of providing a tag customization function, including the following:
user input: allow the user to input or select a user's favorite tag through an intuitive interface;
storage of personalization setting: store the tag defined by the user in a personal setting or configuration file;
personalized application: set a recommended system and content display based on the tag defined by the user during playback of the song; and
interactive feedback: provide a feedback mechanism and, for example, notify the user how a custom tag such as a voice command of “want to make this song include little bit sorrow” affects music playback experience.

5. Processing of recommending a tag based on past preference of the user, including the following:
data analysis: collect and analyze history data of the user including selected songs, preference of tags, and feedback;
pattern identification: identify a typical pattern and preference in user behavior using a data mining technique;
recommendation of personalization: recommend a new tag that matches past preference of the user to the user based on the identified pattern; and
continuous optimization: continue to optimize a recommendation logic through a machine learning algorithm so as to ensure that the recommendation is more personalized and becomes more accurate as time passes.

In some examples, it is possible to update the music file by adjusting the music tag, that is, put a tuning function into use based on adjustment of the music tag.

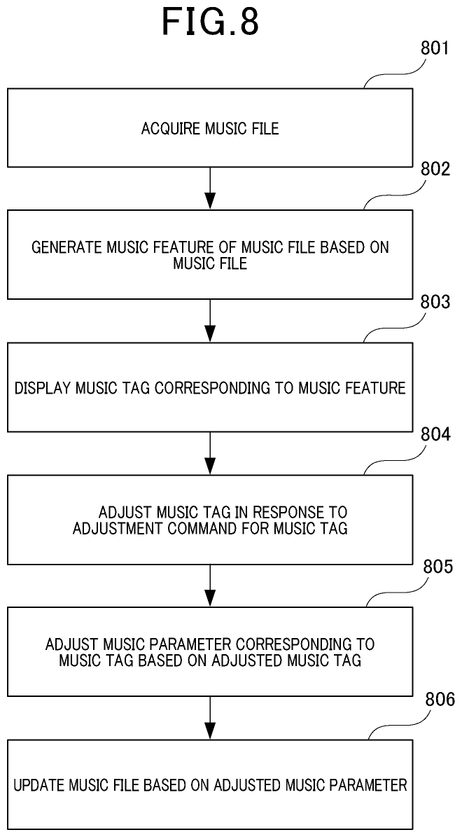

FIG. 8 is another block diagram of the multimedia processing method according to the example of the present invention. As indicated in FIG. 8, the method includes the following steps:
step 801: acquire a music file;
step 802: generate a music feature of the music file based on the music file;
step 803: display a music tag corresponding to the music feature;
step 804: adjust the music tag in response to an adjustment command for the music tag;
step 805: adjust a music parameter corresponding to the music tag based on the adjusted music tag; and
step 806: update the music file based on the adjusted music parameter.

By this means, a music updating function based on adjustment of the music tag, that is, a tuning function can be put into use, which improves the user experience.

In some examples, step 801 and step 802 can be specifically performed with reference to step 101 and step 102, or the music file can be acquired, and the music feature can be generated in any other ways. Further, the method indicated in FIG. 8 can be used in combination with at least one of the method indicated in FIG. 1, the method indicated in FIG. 6, or the method indicated in FIG. 7, and this is not limited by the example of the present invention.

In some examples, steps 804 to 806 can be specifically performed with reference to steps 602 to 606, and thus, description will not be repeated here.

For example, in a similar manner to step 602, the adjustment command in step 804 is generated based on a voice command and/or operation on the displayed widget. By this means, the image and/or the music can be adjusted in various ways, which improves usability for the user.

For example, the music can be adjusted by adjusting an equalizer (EQ) using voice. Specifically, the processing can include the following processing processes:
user input analysis: identify an adjustment command input through user's voice by speech recognition, and convert into the adjustment command of the corresponding tag;
EQ search: identify an adjustment command input by the user through speech recognition, and then, match an existing EQ curve that matches the adjustment command in a constructed EQ library in which EQ curves are classified for each tag;
EQ matching: associate the adjustment command with the existing EQ curve with a shortest k distance in the EQ library through classification using a language model;
application to EQ: receive adjustment setting by the user, apply the matched existing EQ curve to the audio signal, and generate a sound effect after adjustment in real time;
calling of tuning interface: convert the matched existing EQ curve into a command for playback software; and
amplifier processing: receive the command by an amplifier, reflect the command in the audio signal stream after DSP processing, and play back the adjusted sound effect in real time.

In some examples, after step 806, the method can further include a step of updating the image that matches the music file based on the updated music file, and a step of playing back the music corresponding to the updated music file and displaying the updated image in synchronization with the music. This allows the user to intuitively feel the feedback of the adjustment effect from both auditory and visual perspectives.

In some examples, it is possible to construct a user profile in advance and generate and/or adjust the image and/or the music based on the user profile. For example, a basic attribute profile is generated based on demographic characteristics and economic and social attributes, a technology usage profile is generated based on a usage habit of a smart device by the user and preference of an AI application, and a profile of a sense of values and needs is generated based on core motivation of the user and priority of pain points.

In some examples, after adjusting the image and/or the music, the user can store the adjusted image and/or music file and can read the stored file as necessary.

For example, a current image and/or music file is stored by a save button, and a load button is separately provided, so as to allow the user to read the stored file.

In some examples, a list or a folder structure is provided, so that the user can organize and manage user settings and definitions.

In some examples, the user can define an export file such as a JSON format file and easily share and import a file between different devices.

In some examples, after adjusting the image and/or the music, the user can also share the image and/or the music. For example, the user shares the image and the music with other people through a network platform or shares the adjusted EQ.

In some examples, it is possible to optimize the user interface (UI) and improve the user experience (UE) by the following measures:
display tag: it is necessary to display a tag on the user interface;
make tag user-friendly: employ a user interface design having a high level of visualization of strength of adjustment, such as a chart and a slider;
synchronize user interface: adjust the tag by the user, and then, ensure that display of the tag is in synchronization with a current state. For example, in a case where the user inputs a custom tag 1, it is necessary that the tag 1 is timely displayed in a list of tags. In a case where the user adjusts a magnitude of a weight of an existing tag 2, it is necessary that a display effect of the tag 2 is timely strengthened in the list of tags;
optimize layout: timely adjust preference priority of tags of the user to achieve a better match with the intuition and the habit of the user; and prompt how to use: in a case where a page of the user stops for 15 seconds or longer, prompt the user how the custom tag affects the music playback experience.

In some examples, at the time of model training, by utilizing pre-training to achieve needs that the image to be generated matches the EQ that is currently being called, a matching rate of the model can be improved.

An example of the multimedia processing method according to the example of the present invention will be described below through specific cases:

Scene to which the multimedia processing method is to be applied can include the following examples:
scene 1: commuting scene. For example, the user turns on music on a congested elevated highway, but sound of the music is muffled due to horn of a truck and noise of tires. While this affects an auditory sense, the user cannot perform adjustment in real time, and an audio function in related art does not have a correlated adjustment port;
scene 2: driving scene. For example, the user wants to experience scenery and atmosphere outside the window in an immersive manner and make the atmosphere inside the vehicle resonate with the atmosphere outside the vehicle. However, while linguistic expression of the user is ambiguous, a speech recognition function in related art does not have a correlated processing capability;
scene 3: home scene. For example, while there is a case where the whole family goes out together and it is desired to perform adjustment at a word such as, for example, “perform adjustment to make it easy to listen for the elderly”, and “adjust an effect of animation”, a sound function in related art does not have a correlated user-friendly adjustment item; and
scene 4: social scene. For example, it is desired to visualize music and share the generated image and EQ.

Case 1: if the user operates a display of a terminal device (in-vehicle terminal) mounted on a vehicle and selects music that the user desires to play back and/or edit, the in-vehicle terminal locally acquires a music file corresponding to the music or acquires a music file corresponding to the music from a server on a cloud in response to selection by the user, generates a music feature of the music file based on the music file acquired by the in-vehicle terminal, determines an image theme and a visual template that match the music feature based on an artificial intelligence model, extracts an image feature for which correlation with the music feature satisfies a preset condition from the image database based on the artificial intelligence model, generates an image that matches the music file based on the image theme, visual template, and image feature, plays back the music, displays the generated image in synchronization with the music, and during a playback process of the music corresponding to the music file, dynamically updates at least one of a display parameter, display content, or a display format of the image based on at least one of a playback time, a structure, rhythm, a volume, or change of a feeling of the music.

Case 2: if the user operates a display of a terminal device (in-vehicle terminal) mounted on a vehicle and selects music that the user desires to play back and/or edit, the in-vehicle terminal transmits music information selected by the user to a server on a cloud in response to selection by the user, the server on the cloud calls a music file corresponding to the music from a music database, generates a music feature of the music file based on the acquired music file, determines an image theme and a visual template that match the music feature based on an artificial intelligence model, extracts an image feature for which correlation with the music feature satisfies a preset condition from the image database based on the artificial intelligence model, generates an image that matches the music file based on the image theme, the visual template, and the image feature, and transmits the music file and the image that matches the music file to the in-vehicle terminal, and the in-vehicle terminal plays back the music, displays the image that matches the music file in synchronization with the music, and during a playback process of the music corresponding to the music file, dynamically updates at least one of a display parameter, display content, or a display format of the image based on at least one of a playback time, a structure, rhythm, a volume or change in a feeling of the music.

Through the above-described examples, by generating a vivid and unique image with a high matching degree with the music file based on the image theme and the visual template that match the music feature of the music file and the image feature related to the music feature, the image that matches the music file can be displayed in synchronization with the music during playback of the music.

Further, the image is generated using the image theme and the visual template that match the music feature in combination with the image feature related to the music feature, and thus, the generated image embodies the music feature from a plurality of dimensions. Thus, the display format, content and details of the image become enriched, and if the generated image is displayed at the same time as the music being played back, the user can intuitively feel characteristics and sense of the music from both auditory and visual perspectives, which easily attracts sympathy and effectively improves the user experience.

### Example of Second Embodiment

An example of a second embodiment of the present invention provides a multimedia processing apparatus corresponding to the multimedia processing method according to the example of the first embodiment of the present invention, that is, the multimedia processing apparatus is a multimedia processing apparatus that implements the multimedia processing method according to the example of the first embodiment. Concerning functions of the multimedia processing apparatus, the description of the example of the first embodiment can be referred to, and thus, any redundant content will not be repeated in detail.

In some examples, the multimedia processing apparatus is a multimedia playback device or part of the multimedia playback device, or a mobile terminal or part of the mobile terminal, or an in-vehicle terminal or part of the in-vehicle terminal, or a server on a cloud or part of the server on the cloud.

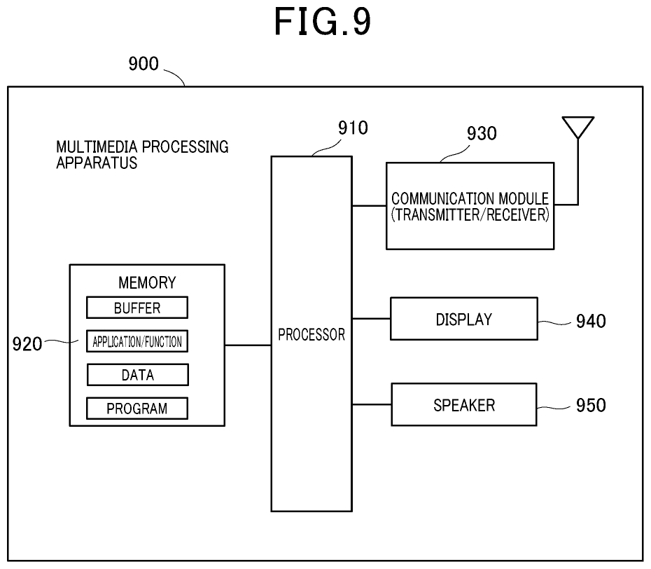

FIG. 9 is a block diagram of the multimedia processing apparatus according to the example of the present invention. As illustrated in FIG. 9, a multimedia processing apparatus 900 can include a processor 910 and a memory 920, and the memory 920 is coupled to the processor 910. Note that the drawing is an example, and a telecommunication function and other functions can be implemented by supplementing or replacing the structure using other types of configurations.

In one embodiment, the processor 910 may be configured to acquire a music file, generate a music feature of the music file based on the music file, determine an image theme and a visual template that match the music feature, determine an image feature related to the music feature, and generate an image that matches the music file based on the image theme, the visual template, and the image feature.

In the example of the present invention, the description of the correlated steps in the example of the first embodiment of the present invention can be referred to for implementation of the functions of the processor 910, and thus, description will not be repeated here.

Further, as illustrated in FIG. 9, the multimedia processing apparatus 900 may further include a communication module 930, a display 940, and a speaker 950. Note that the multimedia processing apparatus 900 does not have to include all the components illustrated in FIG. 9. Further, the multimedia processing apparatus 900 may include members not illustrated in FIG. 9, for which the correlated technique may be referred to.

Through the above-described example, by generating a vivid and unique image with a high matching degree with the music file based on the image theme and the visual template that match the music feature of the music file, and the image feature related to the music feature, the image that matches the music file can be displayed in synchronization with the music during playback of the music.

Further, the image is generated using the image theme and the visual template that match the music feature in combination with the image feature related to the music feature, and thus, the generated image embodies the music feature from a plurality of dimensions. Thus, the display format, content and details of the image become enriched, and if the generated image is displayed at the same time as the music being played back, the user can intuitively feel characteristics and sense of the music from both visual and auditory perspectives, which easily attracts sympathy and effectively improves the user experience.

### Example of Third Embodiment

An example of a third embodiment of the present invention provides a multimedia system, and the multimedia system can include the multimedia processing apparatus (that is the multimedia processing apparatus that implements the multimedia processing method according to the example of the first embodiment) according to the example of the second embodiment. Concerning content of the multimedia processing method, content of the description of the example of the first embodiment can be referred to, and thus, any redundant content will not be repeated in detail.

In some examples, the multimedia system is a multimedia playback device or part of the multimedia playback device, or a mobile terminal or part of the mobile terminal, or an in-vehicle terminal or part of the in-vehicle terminal, or a server on a cloud or part of the server on the cloud.

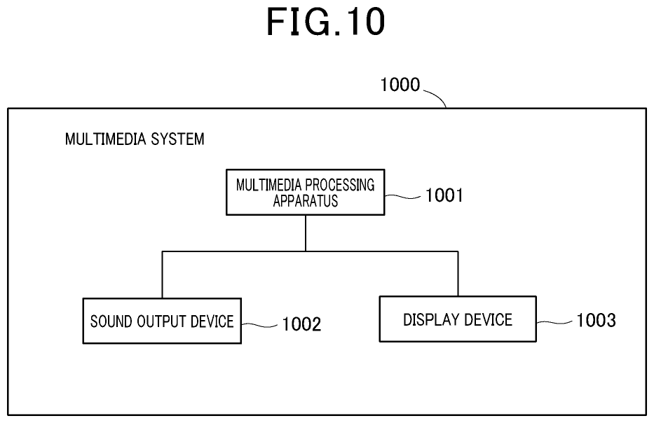

FIG. 10 is a block diagram of the multimedia system according to the example of the present invention.

As illustrated in FIG. 10, a multimedia system 1000 includes a multimedia processing apparatus 1001, a sound output device 1002 that outputs music corresponding to the music file, and a display device 1003 that, when the music corresponding to the music file is output, displays the image that matches the music file in synchronization with the music.

In some examples, the multimedia processing apparatus 1001 may be the same as the multimedia processing apparatus according to the example of the second embodiment.

In some examples, the sound output device 1002 may include sound output devices of various types and in various scenes, for example, a speaker, a headphone, or the like, and may be, for example, a speaker inside a vehicle, and the like.

In some examples, the display device 1003 may include display devices of various types and in various scenes, for example, a display, and may be, for example, a display screen of an in-vehicle terminal inside a vehicle.

Through the above-described example, by generating a vivid and unique image with a high matching degree with the music file based on the image theme and the visual template that match the music feature of the music file, and the image feature related to the music feature, the image that matches the music file can be displayed in synchronization with the music during playback of the music.

Further, the image is generated using the image theme and the visual template that match the music feature in combination with the image feature related to the music feature, and thus, the generated image embodies characteristics of the music from a plurality of dimensions. Thus, the display format, content and details of the image become enriched, and, if the generated image is displayed at the same time as the music being played back, the user can intuitively feel characteristics and sense of the music from both visual and auditory perspectives, which easily attracts sympathy and effectively improves the user experience.

### Example of Fourth Embodiment

An example of the present invention provides a vehicle, and the vehicle includes the multimedia processing apparatus according to the example of the second embodiment or the multimedia system according to the example of the third embodiment.

In some examples, the vehicle may include vehicles of various applications, for example, a compact car, a truck, and the like.

In some examples, the vehicle may include vehicles including various power sources, for example, a fuel cell vehicle, a new energy vehicle, a hybrid vehicle, and the like.

By applying the multimedia processing method according to the example of the first embodiment of the present invention, the multimedia processing apparatus according to the example of the second embodiment, or the multimedia system according to the example of the third embodiment to a vehicle, it is possible to satisfy needs for personalization of a vehicle user, customization, and entertainment functions in the age of big data, achieve user-friendliness and spread of the technique through natural language interaction, multimodal feedback, and emotional design, lead tuning from, for example, an “engineer's field” to “what everyone can enjoy”, provide intuitive feedback and upgrading of experience, make abstract adjustment “visible and sensible” through auditory and visual bidirectional enhancement, and further, provide emotional value. Thereby, the vehicle can provide a further greater “sense of artificial intelligence” to the user through emotional connection, that is, by increasing interactivity of the vehicle functions with the user.

Note that limitation of the respective steps described in the example of the present invention is not regarded as limitation of the order of the steps under assumption of not affecting implementation of a specific method, the step described earlier may be executed first or executed later, or the steps may be executed at the same time, all of which should be regarded as belonging to the scope of the protection of the present invention as long as the present method can be implemented.

While the present invention has been described above by combining specific embodiments, it is clear for a person skilled in the art that all of the description is an example and does not limit the scope of the protection of the present invention. A person skilled in the art can make various modifications and corrections to the present invention based on spirit and principle of the present invention, and these modifications and corrections are incorporated into the scope of the present invention.

What is claimed is:

1. A multimedia processing method comprising:
a step of acquiring a music file;
a step of generating a music feature of the music file based on the music file;
a step of determining an image theme and a visual template that match the music feature;
a step of determining an image feature related to the music feature; and
a step of generating an image that matches the music file based on the image theme, the visual template, and the image feature.

2. The multimedia processing method according to claim 1, wherein the step of acquiring the music file comprises:
a step of acquiring a music file from a local device; or
a step of acquiring a music file from a server on a cloud; or
a step of acquiring a music file created by a user.

3. The multimedia processing method according to claim 1, wherein the step of generating the music feature of the music file based on the music file comprises:
a step of determining at least one main musical element belonging to the music file based on the music file; and
a step of generating a music feature of the music file based on the music file and the main musical element.

4. The multimedia processing method according to claim 3, wherein the step of determining the at least one main musical element belonging to the music file comprises:
a step of analyzing the music file, acquiring a plurality of musical elements, and determining correlation between the music file and the plurality of musical elements; and
a step of selecting from the plurality of musical elements, at least one musical element for which the correlation satisfies a preset condition and setting the at least one musical element as a main musical element belonging to the music file.

5. The multimedia processing method according to claim 4, wherein
a type of the music feature and/or the musical element is determined in advance, and/or
the type of the music feature and/or the musical element is determined based on selection or adjustment by a user.

6. The multimedia processing method according to claim 1, wherein the music feature includes at least one of a musical style, content of lyrics, a feeling and a thought expressed by music, or music rhythm.

7. The multimedia processing method according to claim 6, wherein
the step of determining the image theme and the visual template that match the music feature includes a step of determining an image theme that matches the musical style and/or the content of the lyrics, and a step of determining a visual template that matches at least one of the feeling and the thought expressed by the music or the music rhythm, and/or
the step of determining the image feature related to the music feature includes a step of extracting an image feature for which correlation with the music feature satisfies the preset condition from an image database.

8. The multimedia processing method according to claim 1, wherein the step of determining the image feature related to the music feature includes:
a step of generating a character feature corresponding to the music feature; and
a step of inputting the character feature to an artificial intelligence model and acquiring an image feature related to the music feature.

9. The multimedia processing method according to claim 1, wherein the step of generating the image that matches the music file includes a step of generating the image that matches the music file based on a generative artificial intelligence model.

10. The multimedia processing method according to claim 1, further comprising:
a step of, in a case where the generated music file includes a plurality of music features, determining priority of the plurality of music features, wherein
the step of determining the image theme and the visual template that match the music feature includes a step of determining an image theme and a visual template that match a music feature with the highest priority among the plurality of music features, and/or
the step of determining the image feature related to the music feature includes a step of determining an image feature related to a music feature with the highest priority among the plurality of music features.

11. The multimedia processing method according to claim 1, further comprising:
a step of playing back music corresponding to the music file and displaying the generated image in synchronization with the music.

12. The multimedia processing method according to claim 1, further comprising:
a step of dynamically updating the music feature in real time during a playback process of music corresponding to the music file and dynamically updating the image based on the dynamically updated music feature.

13. The multimedia processing method according to claim 12, wherein the step of dynamically updating the music feature in real time during the playback process of the music corresponding to the music file and dynamically updating the image based on the dynamically updated music feature includes:
a step of updating the music feature based on at least one of a playback time, a structure, rhythm, a volume, or change of a feeling of the music, and dynamically updating at least one of a display parameter, display content, or a display format of the image based on the dynamically updated music feature.

14. The multimedia processing method according to claim 1, further comprising:
a step of adjusting at least one image parameter of the image in response to an adjustment command for the image;
a step of adjusting a music parameter corresponding to the image parameter based on the adjusted image parameter; and
a step of updating the music file based on the adjusted music parameter.

15. The multimedia processing method according to claim 14, wherein
a correspondence relationship between the image parameter and the music parameter is determined in advance, or
a correspondence relationship between the image parameter and the music parameter is determined based on relevance between the image parameter and the image feature, relevance between the image feature and the music feature, and relevance between the music feature and the music parameter.

16. The multimedia processing method according to claim 1, further comprising:
a step of displaying a music tag corresponding to the music feature; and
a step of dynamically updating the music feature in real time during a playback process of music corresponding to the music feature and dynamically updating the music tag based on the dynamically updated music feature.

17. The multimedia processing method according to claim 16, further comprising:
a step of adjusting the music tag in response to an adjustment command for the music tag;
a step of adjusting a music parameter corresponding to the music tag based on the adjusted music tag; and
a step of updating the music file based on the adjusted music parameter.

18. The multimedia processing method according to claim 14, wherein the adjustment command is generated based on a voice command and/or operation on a displayed widget.

19. The multimedia processing method according to claim 14, further comprising:
a step of updating the image that matches the music file based on the updated music file; and
a step of playing back music corresponding to the updated music file and displaying the updated image in synchronization with the music.

20. The multimedia processing method according to claim 1, further comprising:
a step of generating and displaying a recommended adjustment plan correlated with an image and/or a music file based on an analysis result of collected used data.

21. The multimedia processing method according to claim 1, further comprising:
a step of receiving a voice command for adjusting the music file and/or the image, generating a recommended adjustment plan for the music file and/or the image, and updating the music file and/or the image after obtaining confirmation or correction by a user.

22. A multimedia system including a multimedia processing apparatus that implements the multimedia processing method according to claim 1, the multimedia system further comprising:
a sound output device that outputs music corresponding to a music file; and
a display device that, when music corresponding to a music file is output, displays an image that matches the music file in synchronization with the music.

23. A vehicle comprising the multimedia system according to claim 22.
